(19) United States
(12) Patent Application Publication
(10) Pub. No.: US 2026/0062277 A1
(43) Pub. Date: Mar. 5, 2026

(54) WATER DISPENSER

(71) Applicant: STRAUSS WATER LTD, Or Yehuda (IL)

(72) Inventors: Raviv TARANTO, Rishon Lezion (IL); Shilat BITON, Jerusalem (IL)

(21) Appl. No.: 19/380,541

(22) Filed: Nov. 5, 2025

Related U.S. Application Data
(63) Continuation-in-part of application No. PCT/IL2024/050924, filed on Sep. 12, 2024.
(60) Provisional application No. 63/538,335, filed on Sep. 14, 2023.
(60) Provisional application No. 63/631,667, filed on Apr. 9, 2024.

(51) Int. Cl. B67D 1/08; B67D 1/00

(52) U.S. Cl. CPC B67D 1/0882; B67D 1/0085; B67D 1/0857; B67D 1/0895; B67D 2210/00005; B67D 2210/00015

(57) ABSTRACT

The present disclosure provides water dispensers for use in Jewish holy-days, that provide hot and cold water dispensing in week-day mode and in holy-day mode without violating Jewish religious requirements concerning utilization of electricity and water heating on holy-days.

### TECHNOLOGICAL FIELD

The present disclosure concerns water dispensers, more specifically water dispensers for use in Jewish holy-days.

### BACKGROUND

Jewish religion imposes various restrictions on utilization of electrical appliances during holy-days, typically during Sabbath. Water dispensers which provide cooling and/or heating functionalities are such appliances.

Typically, utilization of electrical water dispensers during Sabbath is restricted, primarily with respect to on-demand cooling or heating of water therein, and/or utilization of electrical valves for water dispensing. Further, specific restriction apply during Sabbath on water heating. In order to provide for hot drinking water during the Sabbath, special appliances that provide constant-heating devices are used, into which water is pre-filled and heated before Sabbath. Such devices are usually stand-alone devices (i.e. separate from the integral hot-cold water dispenser), that need to be primed before Sabbath, and occupy significant kitchen counter space. Further, often such devices do not include water filtering functionalities, and hence cannot provide filtered or purified water for consumption.

### GENERAL DESCRIPTION

The present disclosure concerns a water dispenser that is suitable for operation during week-days and during Sabbath, while maintaining Jewish Halacha requirements, that enables the user to dispense, on-demand, cold and hot purified water both during weekdays and holy-days.

Halacha refers to the body of Jewish law, supplementing the scriptural law that forms the legal part of the Talmud. The Halacha is the basis for various limitations imposed on a Jewish observing person, inter alia actions that are not permitted to carry out during various holy-days, such as the Sabbath.

In the dispensers of this disclosure, dispensing of cold and hot water follows Jewish Halacha customs, permitting operation of the dispenser in both week-days and holy-days, without the need to detach the dispenser from the water source during holy-days.

According to one of its aspects, the present disclosure provides a water dispenser having a week-day operation mode and a holy-day operation mode, the dispenser comprises: a pressurized water feed line for receiving pressurized water from a pressurized water inlet; a water treatment unit, in selective liquid communication with the pressurized water feed line through a first electromechanical valve fitted in the pressurized water feed line, the water treatment unit being configured to remove one or more contaminants from the water to obtain treated water; a main water feed line, being in liquid communication with said water treatment unit to receive said treated water; a cold water reservoir, configured to receive treated water from the main feed line through a first feed line, the cold water reservoir being in selective liquid communication with the first feed line through a second electromechanical valve fitted in the first feed line; a cold water dispensing nozzle, in liquid communication with said cold water reservoir, configured for on-demand dispensing of cold water; a hot water reservoir, configured to receive treated water from a second feed line, the second feed line being in selective liquid communication with the main feed line through a check-valve fitted between said main feed line and said second feed line and configured to permit passage of water from the main feed line to the hot water reservoir through the second feed line; and a hot water dispensing nozzle, in liquid communication with said hot water reservoir, configured for on-demand dispensing of hot water via a third electromechanical valve; during operation in week-days mode: (i) said first, second and third electromechanical valve being operated electrically on demand of cold or hot water, and (ii) the check valve permits passage of water from the main feed line to the hot water reservoir through the second feed line; and during operation in holy-day mode: (i) said first, second and third electromechanical valves being operated mechanically, and (ii) the first and second electromechanical valves being mechanically coupled one to the other, such that mechanical opening the first electromechanical valve occurs at a delay from mechanical opening of the second electromechanical valve, the opening of the first electromagnetic valve at said delay from the second electromagnetic valve causes reduction in water pressure in the main feed line during dispensing of cold water from the cold water reservoir, thereby maintaining the water pressure in the main feed line below a pre-determined pressure threshold, such that the check valve is maintained closed to prevent water flow into the second feed line.

In other words, the dispenser of this disclosure comprises an arrangement of valves, configured to operate both electrically and mechanically. On week-day mode, the electromechanical valves are electrically operated to feed water into the cold and hot water reservoirs and provide cold and hot water therefrom on demand. When switched to holy-day mode, the electric operation of the valves is disabled and the valves are configured for timed mechanical operation (i.e. without electrical operation that violates Halacha requirements) to permit continuous on-demand dispensing of cold water. In addition, the timed operation of the mechanical valves, as will be further explained below, causes the water pressure in the main feed line to be maintained below a pre-determined threshold pressure, such that the water pressure in the main feed line is insufficient to open the mechanical check valve in holy-day mode. This prevents re-filling of the hot water reservoir, thereby preventing boiling of cold water during the Sabbath to meet Halacha requirements.

The term holy-day refers to days in which, inter alia, operation of electric devices is not permitted according to Halachic requirements. According to some embodiments, said holy-day is Sabbath, Yom Kippur, or other Jewish festive days in which restrictions on electricity usage and/or water heating exist. The term week-day refers to any other day in the Jewish calendar which is not a holy-day as defined herein.

By some embodiments, the holy-day is Sabbath.

In some embodiments, the first and second electromechanical valves are mechanically linked to provide a delay of at least 0.01 sec, e.g. between about 0.01 and about 0.5 secs, between mechanical opening of the second electromechanical valve and mechanical opening of the first electromechanical valve in the holy-day mode. In other words, as electric induction to dispense water is prevented on holy-days, dispensing of cold water when in holy-day mode can be made only by mechanical operation of a dispensing button that causes mechanical opening of the second electromechanical valve, to allow pressure drop and passage of residual water though the first feed line, and after a pre-defined time delay (obtained by the mechanical coupling of the valves), mechanical opening of the first electromechanical valve occurs to permit flow of water through the main feed line. Hence, gradual feeding of water into the cold water reservoir occurs during holy-day mode, without build-up of pressure in the main feed line.

Such mechanical gradual opening of the first and second electromechanical valves in holy-day mode causes a pressure-drop in the main feed line, thereby preventing formation of water pressure in the main feed line that exceeds the water pressure threshold of the mechanical check valve, thereby preventing passage of water therethrough and preventing introduction of fresh water into the hot water reservoir. Further, the gradual opening reduces the risk of an uncontrolled water pressure spike in the main feed line. Therefore, the delay between the mechanical opening of the first and second electromechanical valves in the holy-day mode is utilized as a mechanism to prevent operation of the check valve, thereby preventing water feeding into the second feed line to maintain the Halacha limitations on heating of fresh water during the holy-day, as will be also explained below.

It is to be noted that the pre-determined pressure threshold refers to the water pressure formed in the second feed line. In other words, the pre-determined pressure threshold is the pressure formed in the second feed line after any pressure drop due to any water treatment functionalities that may exist in the main feed line (for example, one or more water filters, such as those described below).

According to some embodiments, each of the cold water dispensing nozzle and the hot water dispensing nozzle comprises at least one electrical operation button for on-demand dispensing of cold and hot water, respectively, on week-day mode, and mechanical buttons for on-demand dispensing of cold and hot water, respectively, on holy-day mode. When in holy-day mode, the electrical operation buttons are disabled, such that water dispensing can only be made by manually operating the mechanical operation buttons when dispensing of cold or hot water is required.

As noted, the dispenser comprises a mechanical linking mechanism, that links between the first electromechanical valve and the second electromechanical valve, to cause their delayed mechanical operation when in holy-day mode.

According to some embodiments, the mechanical linking mechanism comprises a movement transitioning member that is mechanically linked to one or more cold-water dispensing mechanical operation buttons; a first actuation element integral with said movement transitioning member, and configured for engaging with the first electromechanical valve; and a second actuation element integral with the movement transitioning member, and configured for engaging with the second electromechanical valve; the first and second actuation elements are configured to engage the second and first electromechanical valves, respectively, at a time difference of at least about 0.01 sec.

According to such embodiments, the first electromechanical valve has a first plunger, configured to reciprocate along a first stroke between a pressurized water flow blocking position and a pressurized water flow permitting position, the first actuation element being configured to displace the first plunger along said first stroke; the second electromechanical valve has a second plunger, configured to reciprocate along a second stroke between a treated water flow-blocking position and a treated water flow-permitting position, the second actuation element being configured to displace the second plunger along said second stroke; wherein, upon application of pressure on the one or more cold-water dispensing mechanical operation buttons, the movement transitioning member is configured to simultaneously displace the first and second actuation elements into simultaneous engagement with the respective first and second plungers, and wherein the first stroke is larger than said second stroke, such that the first plunger reaches said treated water flow-permitting position at least about 0.01 sec after the second plunger reaches its pressurized water flow-permitting position.

In other words, the first and second electromechanical valves have plungers with different strokes, such that simultaneous engagement of the first and second actuation elements with the respective second and first plungers, causes a delay between opening actions of the valves.

As noted, according to Halacha requirements, boiling of cold water is prohibited during Sabbath. Hence, in the dispenser of this disclosure, when the dispenser is switched to holy-day mode, no re-filling or topping-off of the water level in the hot water reservoir is permitted. In the dispenser of this disclosure, prevention of water feed into the hot water reservoir on holy-day mode is obtained by the mechanical check valve, which is positioned between the main feed line and the second feed line, and opens to permit flow of treated water through the second feed line only when the pressure in the main line exceeds a pre-determined pressure. According to some embodiments, said pre-determined pressure is at least about 0.2 bar. Namely, the timed gradual mechanical opening of the first and second electromechanical valves in holy-day mode causes a pressure drop in the main feed line to below the pre-determined pressure, such that the check valve is maintained closed to prevent water flow through the second feed line and into the hot water reservoir during holy-day mode, while permitting flow of treated water through the second feed line at week-day mode. As noted, the delay between the mechanical opening of the first and second electromechanical valves on holy-day mode is a mechanism to control the water pressure in the main feed line, thereby preventing undesired breach of the check valve's threshold pressure when the dispenser is operated in holy-day mode.

According to some embodiments, the pre-determined pressure is between about 0.2 bar and about 1.5 bar, e.g. about 0.4 bar and about 1 bar.

Thus, for provision of hot water during holy-day mode, the hot water tank is pre-filled with treated water through the second feed line and heated before onset of the holy-day (e.g. before onset of Sabbath). At the onset of the holy-day, the electric operation of the electromechanical valves is disabled, permitting only operation of these valves in a user-induced mechanical manner. In the mechanical operational mode, the first and second valves are mechanically linked, such that a single mechanical actuation operation causes the second valve to open first, followed by opening of the first valve. This gradual opening causes a pressure reduction in the main feed line to below the pre-defined threshold, such that the pressure in the main feed line is insufficient to cause opening of the check valve, and no re-filling or topping-off of water in the hot water reservoir can be obtained. This results in a limited volume of hot water for consumption during the holy-day, such volume is maintained at a pre-defined temperature with the hot water reservoir throughout the holy-day, as will be explained below.

According to some embodiments, the hot water reservoir has a volume of between about 4 liters and about 9 liters.

According to some embodiments, the hot water reservoir comprises a first heating element, operating in low capacity to maintain a constant average temperature, and a second heating element operating intermittently at high capacity. The first heating element maintains a constant temperature of the water in the hot water reservoir at a low heating capacity, while the second heating element operates intermittently at higher capacity in order to heat the water on-demand.

Preferably, the first and second heating elements are operated simultaneously both in week-day mode and holy-day mode. In such embodiments, the second heating element provides intermittent heating pulses according to a pre-defined timing during holy-day mode (in parallel to the baseline temperature maintained by the first heating element).

The first heating element may, according to some embodiments, be a heating element having a nominal capacity of between about 40 W and about 400 W, and is operated at about 10-25% of the nominal capacity. According to other embodiments, the first heating element may be operated at an average of between about 10 W/10 seconds to about 100 W/10 seconds.

According to other embodiments, the hot water reservoir comprises a single heating element, with a variable heating capacity. In such embodiments, the heating capacity of the heating element is variable to provide a first heating capacity during week-day mode and a second heating capacity during holy-day mode, the second heating capacity being lower than the first heating capacity (provided that the second heating capacity is higher than zero).

As noted, hot water is dispensable from the hot water reservoir through a third electromechanical valve, that is operated electrically on week-day mode and mechanically during holy-day mode. According to some embodiments, the third electromechanical valve is disposed along a hot water dispensing line, said hot water dispensing line extending between a hot water outlet of the hot water reservoir and the hot water dispensing nozzle.

By some embodiments, the hot water outlet is located at a bottom portion of the hot water reservoir, such that dispensing of hot water from the hot water reservoir is gravitational.

According to some embodiments, the first and second heating elements are disposed at a bottom portion of the hot water reservoir, and the hot water outlet is disposed at said bottom portion above said first and second heating elements. Such an arrangement can ensure that once the water level drops below the hot water outlet, hot water can no longer be dispensed out of the hot water reservoir during holy-day mode, however sufficient water is left within the hot water reservoir to maintain the first and second heating elements substantially submerged to prevent overheating or damage to the heating elements (as the hot water reservoir cannot be re-filled at holy-day mode).

The first, second and/or third electromechanical valves can be any suitable electromechanical valve known per se. The first, second and/or third electromechanical valves can be, for example, those described in co-pending PCT application no. PCT/IL2024/050500, incorporated herein by reference.

According to some embodiments, the dispenser comprises a cooling utility, associated with the cold water reservoir, and configured to cool the water in the cold water reservoir.

By some embodiments, when in holy-day mode, the cooling utility is configured to be operated intermittently in defined time intervals. Namely, when in holy-day mode, the cooling utility is configured to operate automatically in pre-defined time intervals, irrespective of the actual water temperature in the cold water reservoir.

According to some embodiments, when in week-day mode, the cooling utility is operated intermittently, according to a measured temperature of the water in the cold water reservoir. According to some other embodiments, when in week-day mode, the cooling utility is operated continuously.

In order to prevent undesired water accumulation in the hot water dispensing nozzle, the hot water dispensing nozzle may comprise, in some embodiments, a hot water outlet tube and a nipple housing that accommodates a hollow nipple. The hollow nipple has a bottom opening that opens into the hot water outlet tube, such that suction of ambient air into the hot water outlet tube through the hollow nipple and said bottom opening occurs, thereby pushing residual water that may accumulate in the hot water dispensing tube towards a hot water outlet of the hot water dispensing nozzle. In this manner, undesired accumulation of residual water in the hot water dispensing nozzle is minimized, and even prevented.

As noted, the dispenser comprises a water treatment unit for treating the incoming water. The water treatment unit comprises one or more water treatment media, which function to remove one or more contaminants from the water, e.g. particles, microorganisms, heavy metals, etc. According to some embodiments, the one or more treatment media are configured to supplement or add one or more nutrients to the water, e.g. minerals, vitamins, etc. The one or more treatment media can be solid, liquid or gel.

According to some embodiments, the one or more treatment media can be one or more filtering media.

According to some embodiments, the water treatment unit comprises at least one first treatment medium typically configured to mechanically remove particulate contaminants from the water (e.g. a filter paper or fabric), and at least one second treatment medium configured to remove at least heavy metals, microorganisms and/or additional particulate contaminants from the water (e.g. a porous filter block).

According to some embodiments, the dispenser further comprises a scale-removing cartridge, fitted in the second feed line, between the check valve and the hot water reservoir. The scale-removing cartridge typically comprises one or more scale-removing media, i.e. a material or composition that functions to remove scale-forming species (such as calcium carbonate) from the water before feeding into the hot water reservoir.

To provide further treatment of the water, typically for eliminating microorganisms therein, according to some embodiments the dispenser further comprises at least one ultraviolet (UV) radiation water treatment unit configured to treat the water by exposure to UV radiation. The UV radiation water treatment unit is, for example, one or more UV lamps or one or more UV light emitting diode (UV-LED) lamps.

According to some embodiments, the UV radiation water treatment unit is located in the main feed line. According to other embodiments, the UV radiation water treatment unit is located in the first feed line.

By some preferable embodiments, the UV radiation water treatment unit is positioned within the cold water reservoir. For example, the cold water reservoir can include a UV-transparent internal housing located within the reservoir, and configured to house the UV radiation water treatment unit, thereby permitting radiation at suitable UV wavelengths to pass to the water held in the cold water reservoir to eliminate microorganisms'contaminations.

According to some embodiments, the UV radiation water treatment unit is configured to operate continuously or intermittently during week-day mode.

According to other embodiments, the UV radiation water treatment unit is configured to operate continuously or intermittently during holy-day mode. By some embodiments, the UV radiation water treatment unit is configured to operate intermittently during holy-day mode according to a pre-defined operation sequence. By some other embodiments, the UV radiation water treatment unit is configured to be rendered inoperative during holy-day mode.

By some embodiments, the dispenser also comprises an ambient treated water dispensing nozzle, for selective dispensing of treated water at ambient temperature. The ambient treated water dispensing nozzle can be fed treated water directly from the main feed line.

According to some embodiments, the dispenser comprises a control unit, configured to control operation of the dispenser.

By some embodiments, the control unit is configured to switch the dispenser between the week-day mode and the holy-day mode, and vice versa. In some embodiments, the control unit is configured to carry out said switch automatically—i.e. the control unit is configured to automatically switch the dispenser from week-day mode to holy-day mode before onset of the holy-day, and switch the dispenser back to week-day mode at the end of the holy-day. In some other embodiments, the control unit is configured to receive a command from a user to switch the dispenser between week-day mode and holy-day modes.

In some embodiments, the dispenser comprises a pressure regulator and/or a flow restrictor to obtain a constant water pressure at the inlet of the dispenser.

In order to obtain directly observable differentiation between the hot water nozzle and the cold water nozzle, according to some embodiments, said hot water dispensing nozzle and said cold water dispensing nozzle are vertically distanced one from the other along a vertical direction extending normal to a base of the dispenser. In other words, the hot water dispensing nozzle and the cold water dispensing nozzle are located at different vertical locations along the vertical direction of the dispenser.

According to some embodiments, the hot water dispensing nozzle is higher than the cold water dispensing nozzle.

According to other embodiments, cold water dispensing nozzle is higher than the hot water dispensing nozzle.

According to some embodiments, the hot water dispensing nozzle and the cold water dispensing nozzle have substantially the same vertical distance from the base of the dispenser.

The dispenser may comprise at least one drip-tray positioned below the cold water and/or hot water dispensing nozzles, to collect water drops or spillage.

According to some embodiments, the at least one drip-tray comprises a first drip-tray is positioned below said cold water dispensing nozzle and a second drip-tray is positioned below said hot water dispensing nozzle.

By some embodiments, the at least one drip tray is foldable.

By other embodiments, the at least one drip tray is attachably detachable to the water dispenser.

In another one of its aspects, the disclosure provides a water dispenser having a week-day operation mode and a holy-day operation mode, the dispenser comprising:
a pressurized water inlet, connectable to a pressurized water feed line via a water pressure regulator;
a water treatment unit, in selective liquid communication with the pressurized water feed line by a first electromechanical valve fitted in the pressurized water feed line, the water treatment unit being configured to remove one or more contaminants from the water to obtain treated water;
a main water feed line, being in liquid communication with said water treatment unit to receive said treated water;
a cold water reservoir, configured to receive treated water from the main feed line through a first feed line, the cold water reservoir being in selective liquid communication with the first feed line by a second electromechanical valve fitted in the first feed line;
a cold water dispensing nozzle, in liquid communication with said cold water reservoir, configured for on-demand dispensing of cold water;
a hot water reservoir, configured to receive treated water from a second feed line, the second feed line being in selective liquid communication with the main feed line by a check-valve fitted between said main feed line and said second feed line; and
a hot water dispensing nozzle, in liquid communication with said hot water reservoir, configured for on-demand dispensing of hot water via a third electromechanical valve;
during operation in week-days mode: (i) said first, second and third electromechanical valve being operated electrically on demand of cold or hot water, and (ii) the water pressure in the main feed line being above a pre-defined threshold as to permit passage of water from the main feed line to the hot water reservoir through the second feed line; and
during operation in holy-day mode: (i) said first, second and third electromechanical valves being operated mechanically, (ii) the first and second electromechanical valves being mechanically coupled one to the other, such that mechanical opening the first electromechanical valve occurs at a delay from mechanical opening of the second electromechanical valve, and (iii) the water pressure regulator being configured to reduce the water pressure in the main feed line below a pre-determined pressure, such that the check valve is maintained closed to prevent water flow into the second feed line.

In this aspect, on the onset of the holy-day, the pressure in the main feed line is reduced by the water pressure regulator to below the pre-defined threshold, such that the check valve is maintained closed and no re-filling or topping-off of water in the hot water reservoir is permitted. This provides obtaining a pre-defined, limited volume of hot water for consumption during the holy-day, such volume is maintained at a pre-defined temperature with the hot water reservoir throughout the holy-day, as will be explained below.

Any of the embodiments disclosed hereinabove can be incorporated into the dispenser of this aspect as well.

As used herein, the singular form “a”, “an” and “the” include plural references unless the context clearly dictates otherwise.

As used herein, the term about is meant to encompass deviation of ±10% from the specifically mentioned value of a parameter, such as temperature, pressure, capacity, etc.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

Unless the context requires otherwise, the word comprise, and variations such as comprises and comprising, will be understood to imply the inclusion of a stated integer or step or group of integers or steps but not the exclusion of any integer or step or group of integers and steps.

Generally it is noted that the term “...at least one...” as applied to any component of a dispenser according to this disclosure should be read to encompass one, two, three, four, or even more different occurrences of said component in a dispenser of this disclosure.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

### EMBODIMENTS

The present disclosure also encompasses embodiments as defined in the following numbered phrases. It should be noted that these numbered embodiments intend to add to this disclosure and are not intended in any way to be limiting.
1. A water dispenser having a week-day operation mode and a holy-day operation mode, the dispenser comprising:
a pressurized water feed line for receiving pressurized water from a pressurized water inlet;
a water treatment unit, in selective liquid communication with the pressurized water feed line through a first electromechanical valve fitted in the pressurized water feed line, the water treatment unit being configured to remove one or more contaminants from the water to obtain treated water;
a main water feed line, being in liquid communication with said water treatment unit to receive said treated water;
a cold water reservoir, configured to receive treated water from the main feed line through a first feed line, the cold water reservoir being in selective liquid communication with the first feed line through a second electromechanical valve fitted in the first feed line;
a cold water dispensing nozzle, in liquid communication with said cold water reservoir, configured for on-demand dispensing of cold water;
a hot water reservoir, configured to receive treated water from a second feed line, the second feed line being in selective liquid communication with the main feed line through a check-valve fitted between said main feed line and said second feed line and configured to permit passage of water from the main feed line to the hot water reservoir through the second feed line; and
a hot water dispensing nozzle, in liquid communication with said hot water reservoir, configured for on-demand dispensing of hot water via a third electromechanical valve;
during operation in week-days mode: (i) said first, second and third electromechanical valve being operated electrically on demand of cold or hot water, and (ii) the check valve permits passage of water from the main feed line to the hot water reservoir through the second feed line; and
during operation in holy-day mode: (i) said first, second and third electromechanical valves being operated mechanically, and (ii) the first and second electromechanical valves being mechanically coupled one to the other, such that mechanical opening the first electromechanical valve occurs at a delay from mechanical opening of the second electromechanical valve, the opening of the first electromagnetic valve at said delay from the second electromagnetic valve causes reduction in water pressure in the main feed line during dispensing of cold water from the cold water reservoir, thereby maintaining the water pressure in the main feed line below a pre-determined pressure threshold, such that the check valve is maintained closed to prevent water flow into the second feed line.
2. The water dispenser of embodiment 1, wherein the mechanical coupling between said first and second electromechanical valves provides a delay of at least 0.01 sec between mechanical opening of the second electromechanical valve and mechanical opening of the first electromechanical valve in the holy-day mode.
3. The water dispenser of embodiment 2, wherein said delay is between about 0.01 sec and about 0.5 sec.
4. The water dispenser of embodiment 1, wherein said cold water dispensing nozzle and said hot water dispensing nozzle are configured for (i) both electrical and mechanical dispensing operation in said week-day mode, and (ii) for mechanical dispensing operation only in said holy-day mode.
5. The water dispenser of embodiment 1, wherein the first electromechanical valve and the second electromechanical valve are coupled via a mechanical linking mechanism, the mechanical linking mechanism comprises:
a movement transitioning member that is mechanically linked to one or more cold-water dispensing mechanical operation actuators;
a first actuation element integral with said movement transitioning member, and configured for engaging with the first electromechanical valve; and
a second actuation element integral with the movement transitioning member, and configured for engaging with the second electromechanical valve;
the first and second actuation elements being configured to engage the second and first electromechanical valves, respectively, at a time difference of at least about 0.01 sec.
6. The water dispenser of embodiment 5, wherein:
the first electromechanical valve has a first plunger, configured to reciprocate along first stroke between a pressurized water flow-blocking position and a pressurized water flow-permitting position, the first actuation element being configured to displace the first plunger along said first stroke;
the second electromechanical valve has a second plunger, configured to reciprocate along a second stroke between a treated water flow-blocking position and a treated water flow-permitting position, the second actuation element being configured to displace the second plunger along said second stroke;
wherein, upon application of pressure on the one or more cold-water dispensing mechanical operation actuators, the movement transitioning member is configured to simultaneously displace the first and second actuation elements into simultaneous engagement with the respective first and second plungers,
and wherein the first stroke is larger than said second stroke, such that the first plunger reaches said treated water flow-permitting position at least about 0.01 sec after the second plunger reaches said pressurized water flow-permitting position.
7. The water dispenser of embodiment 1, wherein the check valve is configured to permit flow of water into the second feed line at a pre-determined pressure of at least about 0.2 bar.
8. The water dispenser of embodiment 1, comprising a cooling utility for cooling the cold water reservoir, wherein, when in holy-day mode, the cooling utility is configured to be operated intermittently in defined time intervals, irrespective of a measured water temperature in the cold water reservoir.
9. The water dispenser of embodiment 1, wherein the hot water reservoir comprises a first heating element, operating in low capacity to maintain a constant average temperature, and a second heating element operating intermittently at high capacity.
10. The water dispenser of embodiment 9, wherein the first and second heating elements are operated simultaneously both in week-day mode and holy-day mode.
11. The water dispenser of embodiment 1, wherein said water treatment unit comprises at least one filtering medium.
12. The water dispenser of embodiment 1, comprising a scale-removing cartridge, fitted in the second feed line, between the check valve and the hot water reservoir.
13. The water dispenser of embodiment 1, wherein said hot water dispensing nozzle comprises a hot water outlet tube, a nipple housing, and a hollow nipple accommodating in said nipple housing, the hollow nipple having a bottom opening that opens into the hot water outlet tube, the hollow nipple permitting suction of ambient air into the hot water outlet tube through said bottom opening to push residual water accumulating in the hot water dispensing tube towards a hot water outlet of the hot water dispensing nozzle.
14. The water dispenser of embodiment 1, comprising at least one ultraviolet (UV) radiation water treatment unit configured to treat the water by exposure to UV radiation.
15. The water dispenser of embodiment 14, wherein said UV radiation water treatment unit is positioned within the cold water reservoir.
16. The water dispenser of embodiment 1, comprising an ambient treated water dispensing nozzle, for selective dispensing of treated water at ambient temperature.
17. The water dispenser of embodiment 1, wherein said hot water dispensing nozzle and said cold water dispensing nozzle are vertically distanced one from the other along in a vertical direction extending normal to a base of the dispenser.
18. The water dispenser of embodiment 1, comprising at least one drip-tray positioned below said cold water and hot water dispensing nozzles.
19. The water dispenser of embodiment 18, wherein said at least one drip-tray comprises a first drip-tray is positioned below said cold water dispensing nozzle and a second drip-tray is positioned below said hot water dispensing nozzle.
20. The water dispenser of embodiment 18, wherein said at least one drip tray is foldable.
21. The water dispenser of embodiment 18, wherein said at least one drip tray is attachably detachable to the water dispenser.
22. The water dispenser of embodiment 1, comprising a control unit, configured to control operation of the dispenser for switching the dispenser between the week-day mode and the holy-day mode, and vice-versa.
23. The water dispenser of embodiment 22, wherein said control unit is configured to carry out said switch automatically.
24. The water dispenser of embodiment 22, wherein said control unit is configured to receive a command from a user to switch the dispenser between the week-day mode and the holy-day mode, and vice-versa.
25. The water dispenser of embodiment 1, wherein in holy-day mode dispensing of hot water from the hot water reservoir is gravitational.
26. The water dispenser of embodiment 1, further comprising a pressure regulator for regulating the pressure fed into the pressurized water feed line.
27. A water dispenser having a week-day operation mode and a holy-day operation mode, the dispenser comprising:
a pressurized water inlet, connectable to a pressurized water feed line via a water pressure regulator;
a water treatment unit, in selective liquid communication with the pressurized water feed line by a first electromechanical valve fitted in the pressurized water feed line, the water treatment unit being configured to remove one or more contaminants from the water to obtain treated water;
a main water feed line, being in liquid communication with said water treatment unit to receive said treated water;
a cold water reservoir, configured to receive treated water from the main feed line through a first feed line, the cold water reservoir being in selective liquid communication with the first feed line by a second electromechanical valve fitted in the first feed line;
a cold water dispensing nozzle, in liquid communication with said cold water reservoir, configured for on-demand dispensing of cold water;
a hot water reservoir, configured to receive treated water from a second feed line, the second feed line being in selective liquid communication with the main feed line by a check-valve fitted between said main feed line and said second feed line; and
a hot water dispensing nozzle, in liquid communication with said hot water reservoir, configured for on-demand dispensing of hot water via a third electromechanical valve;
during operation in week-days mode: (i) said first, second and third electromechanical valve being operated electrically on demand of cold or hot water, and (ii) the water pressure in the main feed line being above a pre-defined threshold as to permit passage of water from the main feed line to the hot water reservoir through the second feed line; and
during operation in holy-day mode: (i) said first, second and third electromechanical valves being operated mechanically, (ii) the first and second electromechanical valves being mechanically coupled one to the other, such that mechanical opening the first electromechanical valve occurs at a delay from mechanical opening of the second electromechanical valve, and (iii) the water pressure regulator being configured to reduce the water pressure in the main feed line below a pre-determined pressure, such that the check valve is maintained closed to prevent water flow into the second feed line.
28. The water dispenser of embodiment 27, wherein said first and second electromechanical valves are mechanically linked to provide a delay of at least 0.01 sec between mechanical opening of the second electromechanical valve and mechanical opening of the first electromechanical valve in the holy-day mode.
29. The water dispenser of embodiment 28, wherein said delay is between about 0.01 sec and about 0.5 sec.
30. The water dispenser of embodiment 27, wherein said cold water dispensing nozzle and said hot water dispensing nozzle each comprises an electrical operation button for on-demand dispensing of cold and hot water, respectively, on week-day mode, and a mechanical button for on-demand dispensing of cold and hot water, respectively, on holy-day mode.
31. The water dispenser of embodiment 27, wherein the first electromechanical valve and the second electromechanical valve are linked via a mechanical linking mechanism.
32. The water dispenser of embodiment 31, wherein the mechanical linking mechanism comprises:
a movement transitioning member that is mechanically linked to one or more cold-water dispensing mechanical operation buttons;
a first actuation element integral with said movement transitioning member, and configured for engaging with the first electromechanical valve; and
a second actuation element integral with the movement transitioning member, and configured for engaging with the second electromechanical valve;
the first and second actuation elements being configured to engage the second and first electromechanical valves, respectively, at a time difference of at least about 0.01 sec.
33. The water dispenser of embodiment 32, wherein:
the first electromechanical valve has a first plunger, configured to reciprocate along first stroke between a pressurized water flow-blocking position and a pressurized water flow-permitting position, the first actuation element being configured to displace the first plunger along said first stroke;
the second electromechanical valve has a second plunger, configured to reciprocate along a second stroke between a treated water flow-blocking position and a treated water flow-permitting position, the second actuation element being configured to displace the second plunger along said second stroke;
wherein, upon application of pressure on the one or more cold-water dispensing mechanical operation buttons, the movement transitioning member is configured to simultaneously displace the first and second actuation elements into simultaneous engagement with the respective first and second plungers,
and wherein the first stroke is larger than said second stroke, such that the first plunger reaches said treated water flow-permitting position at least about 0.01 sec after the second plunger reaches said pressurized water flow-permitting position.
34. The water dispenser of embodiment 27, wherein said pre-determined pressure is at least about 0.2 bar.
35. The water dispenser of embodiment 27, comprising a cooling utility for cooling the cold water reservoir.
36. The water dispenser of embodiment 35, wherein, when in holy-day mode, the cooling utility is configured to be operated intermittently in defined time intervals, irrespective of a measured water temperature in the cold water reservoir.
37. The water dispenser of embodiment 27, wherein the hot water reservoir comprises a first heating element, operating in low capacity to maintain a constant average temperature, and a second heating element operating intermittently at high capacity.
38. The water dispenser of embodiment 37, wherein the first and second heating elements are operated simultaneously both in week-day mode and holy-day mode.
39. The water dispenser of embodiment 27, wherein said water treatment unit comprises at least one filtering medium.
40. The water dispenser of embodiment 27, comprising a scale-removing cartridge, fitted in the second feed line, between the check valve and the hot water reservoir.
41. The water dispenser of embodiment 27, wherein said hot water dispensing nozzle comprises a hot water outlet tube, a nipple housing, and a hollow nipple accommodating in said nipple housing, the hollow nipple having a bottom opening that opens into the hot water outlet tube, the hollow nipple permitting suction of ambient air into the hot water outlet tube through said bottom opening to push residual water accumulating in the hot water dispensing tube towards a hot water outlet of the hot water dispensing nozzle.
42. The water dispenser of embodiment 27, comprising at least one ultraviolet (UV) radiation water treatment unit configured to treat the water by exposure to UV radiation.
43. The water dispenser of embodiment 42, wherein said UV radiation water treatment unit is positioned within the cold water reservoir.
44. The water dispenser of embodiment 27, comprising an ambient treated water dispensing nozzle, for selective dispensing of treated water at ambient temperature.
45. The water dispenser of embodiment 27, wherein said hot water dispensing nozzle and said cold water dispensing nozzle are vertically distanced one from the other along in a vertical direction extending normal to a base of the dispenser.
46. The water dispenser of embodiment 27, comprising at least one drip-tray positioned below said cold water and hot water dispensing nozzles.
47. The water dispenser of embodiment 46, wherein said at least one drip-tray comprises a first drip-tray is positioned below said cold water dispensing nozzle and a second drip-tray is positioned below said hot water dispensing nozzle.
48. The water dispenser of embodiment 46, wherein said at least one drip tray is foldable.
49. The water dispenser of embodiment 46, wherein said at least one drip tray is attachably detachable to the water dispenser.
50. The water dispenser of embodiment 27, comprising a control unit, configured to control operation of the dispenser.
51. The water dispenser of embodiment 50, wherein said control unit is configured to switch the dispenser between the week-day mode and the holy-day mode, and vice-versa.
52. The water dispenser of embodiment 51, wherein said control unit is configured to carry out said switch automatically.
53. The water dispenser of embodiment 51, wherein said control unit is configured to receive a command from a user to switch the dispenser between the week-day mode and the holy-day mode, and vice-versa.
54. The water dispenser of embodiment 27, wherein dispensing of hot water from the hot water reservoir is gravitational when the dispenser is in holy-day mode.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B are perspective views of a water dispenser according to this disclosure with the drip-trays at a closed position and an open position, respectively.

FIG. 2 is a perspective view of the dispenser of FIG. 1A, with a portion of the top cover removed in order to view some of the internal elements of the dispenser.

FIG. 3 is a schematic hydraulic flow chart of the dispenser of this disclosure.

FIGS. 4A-4B show the water flow in week-day mode and in holy-day mode, respectively.

FIGS. 5A-5E show an exemplary mechanical linking arrangement of the first and second electromechanical valves for operation in holy-day mode, according to an embodiment of this disclosure, at various operational positions, in which:

FIG. 5A is a perspective view in the closed positions of the valves;

FIG. 5B is a longitudinal cross-sectional view along line A-A in FIG. 5A;

FIG. 5C is a perspective view with the cold water dispensing button being pressed;

FIG. 5D is a longitudinal cross-sectional view along line B-B in FIG. 5C, with the second valve being in an open position and the first valve in the closed position; and

FIG. 5E is a longitudinal cross-sectional view along line B-B in FIG. 5C, with both the first and second valves being in the open position.

FIG. 6A is an exploded view of the hot water dispensing nozzle according to an embodiment of this disclosure.

FIG. 6B is a cross section through the hot water dispensing nozzle of FIG. 6A along line C-C, with the nipple fitted within the nipple housing.

### DETAILED DESCRIPTION OF EMBODIMENTS

The dispensers of this disclosure are engineered to fulfill Jewish Halacha requirements for operation during week-days and during Sabbath, to permit on-demand dispensing of cold and hot water. Hence, the dispenser has two operational modes, a week-day mode and a holy-day mode, such that in both modes dispensing of cold and hot water is permitted according to Halachic requirements, as will be explained below.

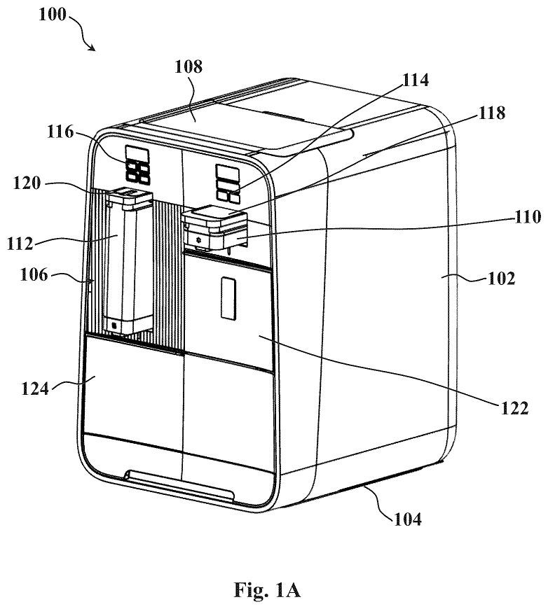

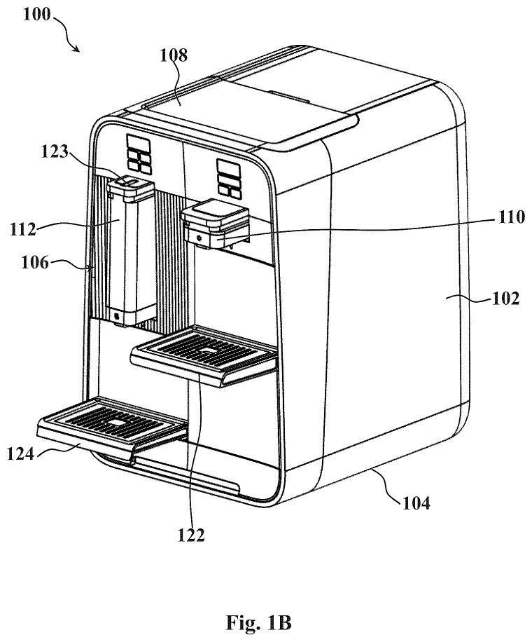

Turning first to FIGS. 1A-1B, shown is an exemplary water dispenser according to an embodiment of this disclosure. Dispenser 100 comprises a housing 102, with a base 104, a front face 106 and a top cover 108. Protruding from the front face 106 are cold water dispensing nozzle 110 and hot water dispensing nozzle 112, that dispense, respectively, cold and hot water on demand from respective cold and hot water reservoirs, as will be further explained below.

As can be seen in this exemplary dispenser, cold and hot water dispensing nozzles 110 and 112 have different vertical distances from base 104, thereby providing direct and unambiguous differentiation therebetween. A user can easily distinguish between the hot and cold nozzles, thereby reducing the risk of confusion between the two. In this specific example, the cold water dispensing nozzle 110 is vertically higher than the hot water dispensing nozzle 112 in a direction normal to base 104; however other arrangements are also possible, for example the cold water dispensing nozzle 110 being vertically lower than the hot water dispensing nozzle 112, or both nozzles being substantially at the same vertical distance from base 104.

Seen also in FIGS. 1A-1B are drip-trays 122 and 124, positioned, respectively, below cold water dispensing nozzle 110 and hot water dispensing nozzle 112. In FIG. 1A the drip-trays assume a closed, folded position, in which the trays are substantially flush with the front face 106 of the dispenser, thereby permitting positioning of large containers or bottles directly below the nozzles for filling. In FIG. 1B the drip-trays 122 and 124 are shown in a non-folded position, in which the trays protrude out of front face 106 and are substantially parallel to the base 104. In the non-folded position, the drip-trays function to collect drops of water that may trickle from the nozzles and/or water spillage. The drip-trays also function to support a cup or a glass that is positioned by the user below the nozzles for dispensing water thereinto. Drip-trays 122 and 124 can also be detachably attached to the dispenser, such that a user can remove the trays for emptying/cleaning and re-attach thereafter.

While in the specific exemplified dispenser two drip-trays are shown, one of each dispensing nozzle, it is also envisaged that a single, common drip tray can be utilized (not shown).

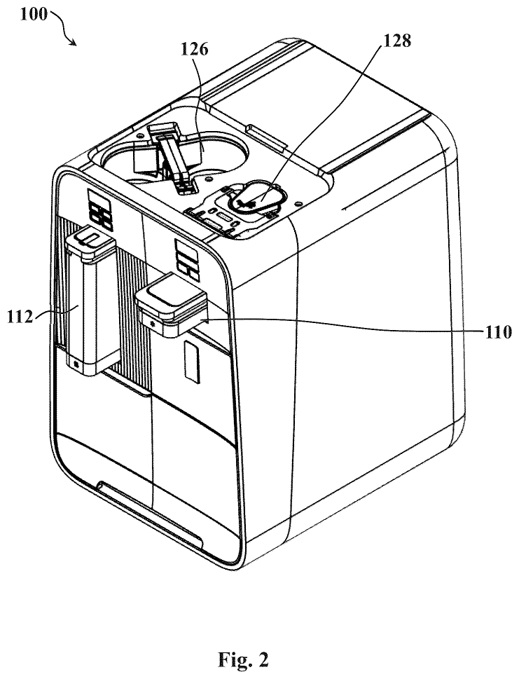

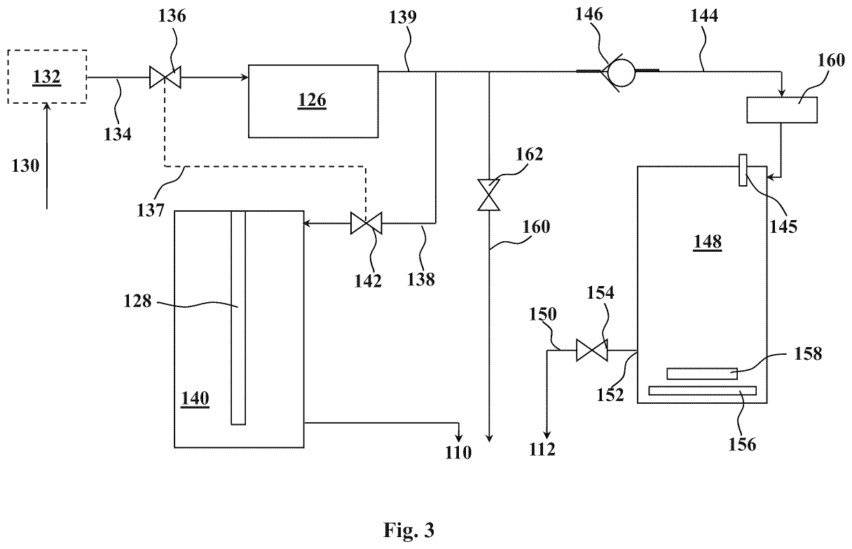

As seen in FIGS. 2-4B, the dispenser comprises a pressurized water inlet 130 that feeds water into a pressurized water feed line 134, optionally via a water pressure regulator/flow restrictor 132. It is noted that the water pressure regulator, when included in the dispenser, functions to regulate the pressure of the water fed into the dispenser through the pressurized water inlet (that is, in turn, fed water from a municipal or domestic water line), thereby mitigating any pressure spikes in the main feed line to instability in water pressure in the municipal or domestic water line. The pressure regulator/flow restrictor, when present, can be part of the dispenser, or can be fitted externally to the dispenser on entry to the dispenser.

Fitted in pressurized water feed line 134 is a first electromechanical valve 136 that controls feeding of pressurized water into water treatment unit 126. In water treatment unit 126, the pressurized water is treated primarily to remove various contaminants, for example by passage through one or more treatment media. An example of a suitable water treatment unit can comprise at least one first treatment medium typically configured to mechanically remove particulate contaminants from the water (e.g. a filter paper or fabric), and at least one second treatment medium configured to remove at least heavy metals, microorganisms and/or additional particulate contaminants from the water (e.g. a porous filter block). The treatment media can also be configured to supplement or add one or more nutrients to the water, e.g. minerals, vitamins, etc.

Treated water exits the water treatment unit 126 into main feed line 139. From the main feed line 139, the treated water can be fed into cold water reservoir 140 and/or hot water reservoir 148, depending on the operation mode of the dispenser, as will now be explained. In the exemplified dispenser, there is also an ambient water line 160, fed water from the main feed line 139, such that ambient water can be dispensed when operating valve 162.

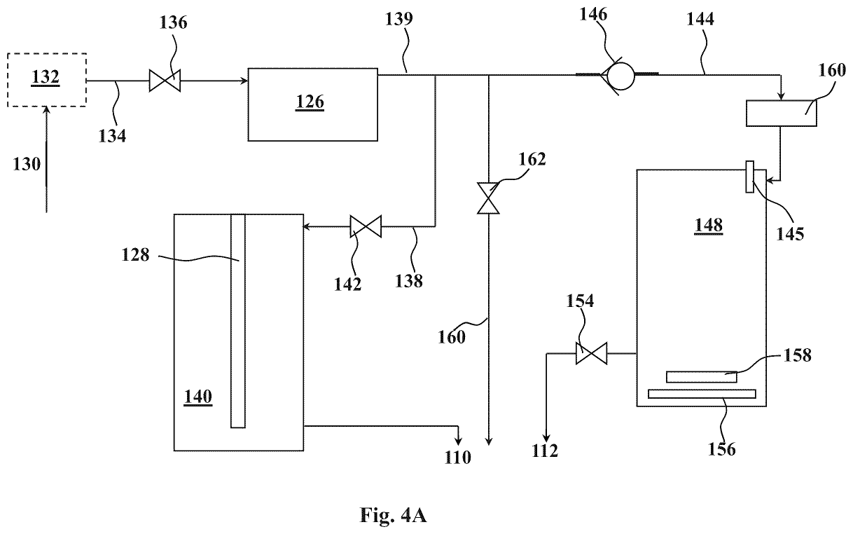

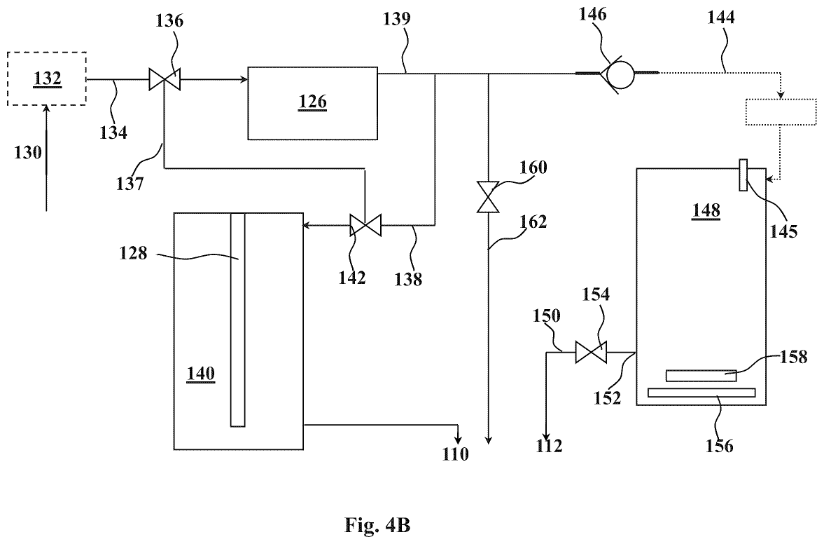

First, operation in week-day mode will be detailed, as exemplified in FIG. 4A. During week-days, treated water is fed from the main feed line 139 to cold water reservoir via first feed line 138, in a selective manner via second electromechanical valve 142. On week-day mode, both first and second electromechanical valves 136 and 142 are concomitantly electrically operated by the dispenser's control unit, when receiving a demand for cold water dispensing via one or more electrical operation buttons 114. However, it is also envisaged that in week-day mode, second electromechanical valve 142 can be normally open, and control over the feeding of water is obtained via first electromechanical valve 136 only.

In cold water reservoir 140, water is cooled to a desired temperature by a cooling utility (not shown), which can be controlled by the control unit, and dispensed through cold water dispensing nozzle 110 upon user demand for cold water.

To further eliminate microorganisms from the water, the dispenser can include at least one ultraviolet (UV) radiation water treatment unit for treating the water by exposure to UV radiation. In the exemplified dispenser, the UV radiation unit is in the form of a UV lamp 128, and is positioned within the cold water reservoir 140 (for example in a UV-transparent internal housing). However, it is also envisaged that the UV radiation water treatment unit be located in the main feed line or in the first feed line.

The UV radiation water treatment unit 128 is configured to operate continuously or intermittently during week-day mode. Typically, the UV radiation treatment unit is operated continuously in week-day mode.

As can be seen in FIG. 2, both water treatment unit 126 and UV radiation treatment unit 128 are user accessible, e.g. by removing top cover 108 of the dispenser, such that a user can periodically replace the water treatment unit and/or UV radiation treatment unit.

Hot water reservoir 148 is fed treated water from the main feed line 139 through second feed line 144. Positioned between main feed line 139 and second feed line 144 is a mechanical check valve 146, having a pre-defined water operation pressure. In week-day mode, dispensing of hot water is permitted by electrical operation of third electromechanical valve 154, while the second electromechanical valve 142 is maintained closed. In this manner, pressure is built in the main feed line 139, and the water pressure is above the pre-defined pressure of the check valve 146, such that water passage through the check valve 146 is permitted during week-day mode to re-fill and maintain a defined level of water in the hot water reservoir 148.

In the hot water reservoir 148, two heating elements are operated: a first heating element 156 that constantly operates at low capacity to maintain a constant average temperature, and a second heating element 158 that is configured to operate intermittently at high capacity in parallel to (i.e. simultaneously with) the first heating element 156. The first heating element may, for example, be a heating element having a nominal capacity of between about 40 and 400 W, and is operated at about 10-25% of the nominal capacity, e.g. operated at an average of between about 10 W/10 seconds to about 100 W/10 seconds.

Hot water is dispensed from the hot water reservoir 148 through hot water outlet 152 into hot water dispensing line 150 and into hot water dispensing nozzle 112 upon user demand (by pressing onto one or more electrical operation buttons 116).

Also included in the second feed line 144 is scale-removing cartridge 160, that typically comprises one or more scale-removing media, i.e. a material or composition that functions to remove scale-forming species (such as calcium carbonate) from the water before feeding into the hot water reservoir. Such a cartridge minimizes formation of scale in the hot water reservoir, reducing the need to frequently clean the reservoir from scale sediments.

As noted above, in holy-days, electrical induction of water dispensing is not permitted. Further, boiling of cold water is further prohibited through the holy-day. Hence, the dispenser is configured to be operated on holy-days in a manner not trespassing Halachic requirements for the holy-days, while permitting dispensing cold and hot water on demand during holy-days. For this purpose, the dispenser is configured to be switched between week-day mode and holy-day mode.

For provision of hot water during holy-day mode, the hot water tank 148 is pre-filled with treated water through the second feed line 144 and heated before onset of the holy-day (e.g. before onset of Sabbath). Upon onset of the holy-day (or shortly therebefore), the dispenser is switched to holy-day mode, in which the electric operation of the first, second and third electromechanical valves (136,142,154, respectively) is disabled.

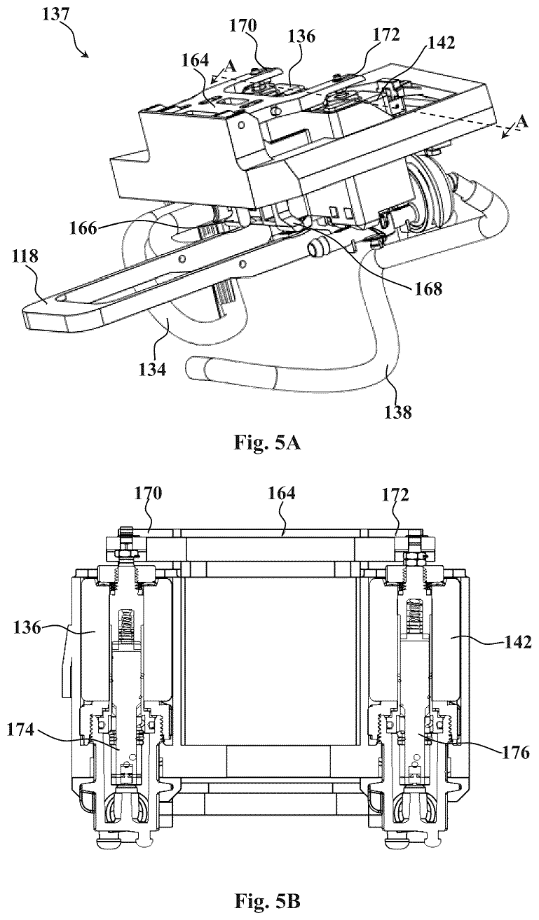

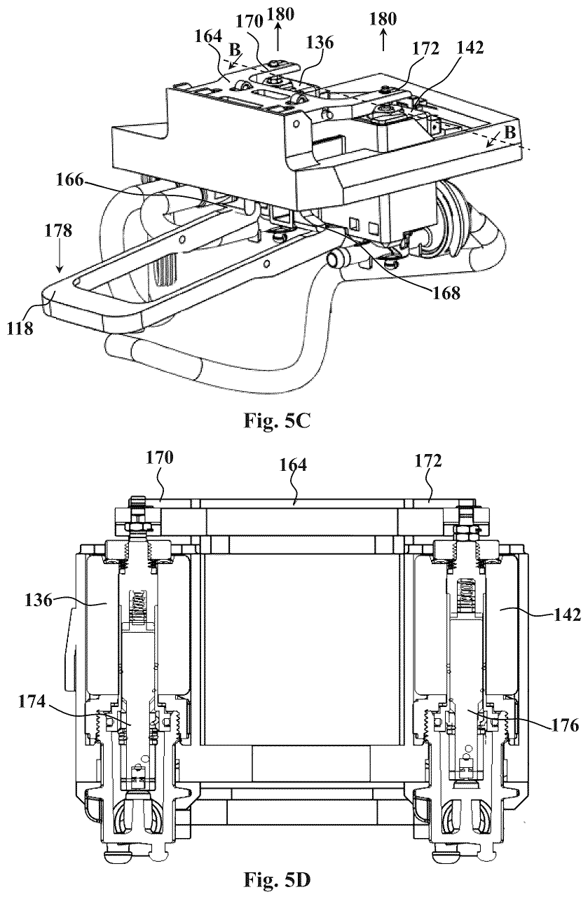

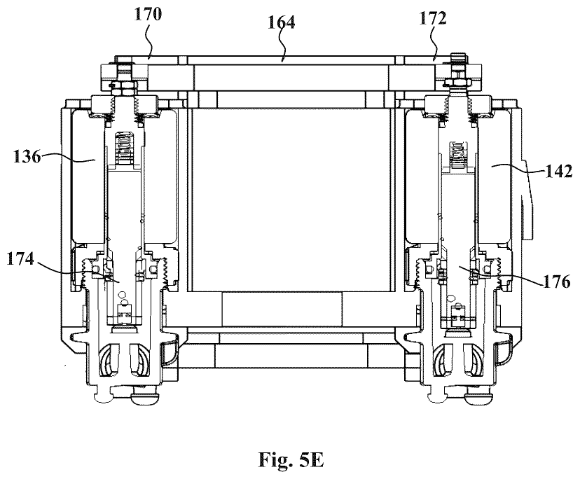

Dispensing of cold water in holy-day mode is, thus, fully mechanically induced by switching the first and second electromechanical valves 136 and 142 to mechanical operation. The first and second electromechanical valves 136 and 142 are mechanically linked by link mechanism 137 (for example the mechanism shown in FIGS. 5A-5E, to be further described below), thereby providing a delay of at least 0.01 sec between mechanical opening of the first electromechanical valve 136 and mechanical opening of the second electromechanical valve 142 in the holy-day mode. In other words, as electrical induction to dispense water is prevented on holy-days, upon a demand for cold-water during holy-day mode mechanical operation of a cold water dispensing button 118 causes mechanical opening of the second electromechanical valve 142 to allow dropping of pressure and passage of residual water through the first feed line 138, and after a pre-defined time delay permitted by the mechanical coupling of the valves 136 and 142, mechanical opening of the first electromechanical valve 136 occurs to permit flow of water through the main feed line 139 and into the first feed line 138. Hence, no direct feeding of water between the main feed line and the first feed line occurs during holy-day mode to meet Halachic requirements.

The gradual mechanical operation of the first and second electromechanical valves in holy-day mode serves as a mechanism to control the water pressure in the main feed line 139, to thereby drop the pressure in the main feed line and prevent undesired breach of the pressure threshold of the check valve 146. In other words, when a user operates the mechanical actuation to dispense cold water in holy-day mode, first the mechanical opening of the second electromechanical valve 142 drops the pressure in the first feed line 138, followed by mechanical opening of the first electromechanical valve 136 that causes drop in water pressure in the main feed line 139 and introduction of water into the cold water reservoir 140 to replenish the cold water dispensed therefrom with fresh water. As the pressure in the main feed line 139 during dispensing of cold water is now below the pressure threshold of the check valve 146, maintaining the check valve closed to prevent water passes into the hot water reservoir. As the check valve is completely mechanical, without any electrical operation, passage of water therethrough can only be obtained when the pressure in the main feed line is above said pre-determined pressure. As the gradual opening of the first and second valves in holy-day mode is designed to drop the pressure in the main feed line when operated, no such build-up of pressure can be obtained during holy-day mode, which will cause undesired introduction of water into the second feed line (and from there into the hot water reservoir).

Dispensing for hot water from the pre-filled volume of water in the holy-day mode is permitted by mechanical operation of third electromechanical valve 154, and the first and second electromechanical valves 136 and 142 remain mechanically closed, thereby preventing fresh water passage through check valve 146 into the hot water reservoir, and preventing re-filling of the hot water reservoir. This provides obtaining a pre-defined volume (e.g. between about 4 and about 9 liters, typically suitable for average consumption of an average family during the holy-day) of hot water for consumption during the holy-day, such volume is maintained at a pre-defined temperature with the hot water reservoir throughout the holy-day by the operation of the heating elements 156 and 158. As hot water reservoir is open to the atmosphere via vent 145, no pressure build-up is formed in the hot water reservoir when hot water is dispensed therefrom.

In another, different configuration, a water pressure regulator 132 can be used to reduce the water pressure in the main feed line 139 during holy-day mode to below the pre-defined threshold, such that the check valve 146 does not open and no re-filling or topping-off of water in the hot water reservoir 148 is permitted.

The first and second heating elements 156 and 158 are operated simultaneously in holy-day mode, with the first heating element 156 maintain constantly operating to maintain a defined average temperature, while the second heating element 158 provides intermittent heating pulses according to a pre-defined timing during holy-day mode (in parallel to the constant temperature maintained by the first heating element).

As noted, hot water is dispensable from the hot water reservoir through a third electromechanical valve 154, that is mechanically operated during holy-day mode. Electromechanical valve 154 is mechanically linked to hot water dispensing mechanical button 120, and hence pressing onto button 120 will cause mechanical opening of the third valve 154 to dispense hot water from the hot water reservoir on-demand.

It is also noted that the hot water dispensing mechanical button 120 comprises a safety lock 123, which is configured to be lockable by the user, as to prevent undesired mechanical operation of button 120, e.g. functioning as a child safety measure.

As can be seen, in this example hot water outlet 152 is located at a bottom portion of the hot water reservoir, thereby permitting gravitational dispensing from the hot water reservoir 148. Further, the first and second heating elements 156 and 158 can be disposed at a bottom portion of the hot water reservoir, with hot water outlet 152 being located above the heating elements. Such an arrangement can ensure that once the water level drops below the hot water outlet, hot water can no longer be dispensed out of the hot water reservoir during holy-day mode, however sufficient water is left within the hot water reservoir to maintain the first and second heating elements substantially submerged to prevent overheating or damage to the heating elements (as the hot water reservoir cannot be re-filled during holy-day mode).

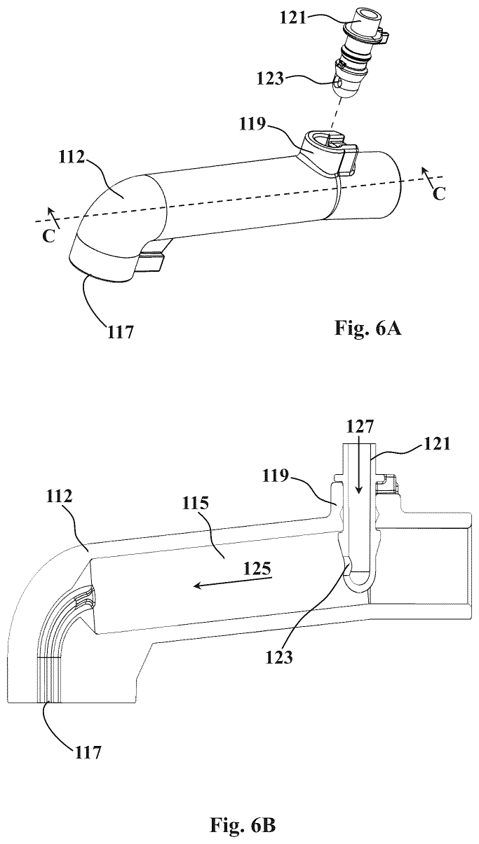

Further, in order to prevent stagnant water accumulation in the hot water nozzle 112, in some arrangements the hot water nozzle can have a water flow acceleration mechanism, such as that exemplified in FIGS. 6A-6B. In this example, hot water nozzle 112 comprises an outlet tube 115, that links between the hot water dispensing line 150 and the hot water outlet tube 115 of dispensing outlet 117. It is noted that outlet tube 115 has an overall downward inclination in order to facilitate draining of water towards the dispensing outlet 117. The dispensing nozzle 112 is configured with a nipple housing 119, that is oriented substantially normal to the longitudinal axis of the outlet tube. The nipple housing 119 houses a hollow nipple 121 that has a bottom opening 123 that opens into outlet tube 115. During dispensing of hot water, hot water flows from the hot water dispensing line 150 through outlet tube 115 towards outlet 117, as represented by arrow 125. The hollow nipple 119 is designed such that upon ceasing of water flow in the outlet tube 115, ambient air is sucked into the outlet tube 115 (as represented by arrow 127) due to the transient low pressure formed therein due to cease of water flow, such that a pulse of air is sucked into the outlet tube 115 through bottom opening 123 to push residual water that may temporarily accumulate in tube 115 towards outlet 117. In this manner undesired accumulation of water in the hot water dispensing outlet 112 is minimized and even prevented.

During holy-day mode the UV radiation water treatment unit 128 can be configured to operate continuously or intermittently during holy-day mode. Typically, UV radiation water treatment unit 128 is configured to operate intermittently during holy-day mode according to a pre-defined operation sequence. In some cases, the UV radiation water treatment unit can be rendered inoperative during holy-day mode.

Hence, operation of the dispenser in holy-day mode differs from operation of the dispenser in week-day mode. In week-days mode (i) each of the first, second and third electromechanical valves 136, 142 and 154, respectively, is operated electrically on demand of cold or hot water, and (ii) the water pressure in the main feed line 139 is above a pre-defined threshold as to permit passage of water from the main feed line 139 to the hot water reservoir 148 through the second feed line 144. In holy-day mode (i) each of the first, second and third electromechanical valves 136, 142 and 154, respectively, is operated mechanically, and (ii) the first and second electromechanical valves 136 and 142 are mechanically coupled one to the other by mechanical link 137, the opening of the first electromagnetic valve at said delay from the second electromagnetic valve causes reduction in water pressure in the main feed line during dispensing of cold water from the cold water reservoir, thereby maintaining the water pressure in the main feed line below a pre-determined pressure threshold, such that the check valve is maintained closed to prevent water flow into the second feed line such that mechanical opening the first electromechanical valve 136 occurs at a delay from mechanical opening of the second electromechanical valve 142. This delay causes reduction in water pressure in the main feed line 139 during dispensing of cold water from the cold water reservoir 140, thereby maintaining the water pressure in the main feed line 139 below a pre-determined pressure threshold, such that the check valve 146 is maintained closed to prevent water flow into the second feed line 144.

The control unit (not shown) is configured to switch the dispenser between the week-day mode and the holy-day mode, and vice versa. The control unit can be configured to carry out such switch automatically—i.e. the control unit is configured to automatically switch the dispenser from week-day mode to holy-day mode before onset of the holy-day, and switch the dispenser back to week-day mode at the end of the holy-day. Alternatively, or additionally, the control unit is configured to receive a command from a user to switch the dispenser between week-day mode and holy-day modes.

Turning now to FIGS. 5A-5E, shown is an exemplary mechanical linking mechanism between the first and second electromechanical valves, that permits delayed coupled mechanical operation of the valves on holy-day mode. The mechanical linking mechanism 137 comprises a movement transitioning member 164 that is selectively mechanically linked to cold-water dispensing mechanical operation button 118, in this case via coupling legs 166, 168, which are integrally formed with movement transitioning member 164. The movement transitioning member 164 is also integral with first actuation element 170 and second actuation member 172.

First actuation member 170 is engaged with the first electromechanical valve 136, and second actuation element 172 is engaged with the second electromechanical valve 142.

Shown in FIGS. 5A-5B is the mechanical linking mechanism in its closed position, when the operation button 118 is not pressed by a user and water flow is prevented via the first and second electromechanical valves (perspective view in FIG. 5A and longitudinal cross-sectional view along line A-A in FIG. 5B). As can be seen in FIG. 5B, the first electromechanical valve 136 has a first plunger 174, shown in FIG. 5B in its pressurized water flow blocking position, and the second electromechanical valve 142 has a second plunger 176 shown in its treated water flow-blocking position.

When a user presses onto cold-water dispensing mechanical operation button 118 during holy-day mode as seen in FIG. 5C, e.g. in the direction of arrow 178, the movement transitioning member 164 transitions the mechanical movement, via integral coupling legs 166, 168 to the first and second actuation elements 170, 172, causing them to simultaneously vertically displace upwards in the direction of arrows 180. As the first and second actuation elements 170, 172 are engaged with the plungers 174 and 176 of the first end second electromechanical valves 136 and 142, respectively, such movement displaces the respective first and second plungers 174 and 176.

As the stroke of the first plunger 174 is larger than the stroke of second plunger 176, the vertical movement in the direction of arrows 180 causes the second plunger 176 to displace first into its pressurized water flow-permitting position, as seen in FIG. 5D, and only thereafter the vertical movement causes displacement of first plunger 174 into its treated water flow-permitting position shown in FIG. 5E. The difference between the plungers'strokes is configured such that the first electromechanical valve opens to permit flow of water therethrough at least about 0.01 sec after the second plunger reaches the pressurized water flow-permitting position. Thus, such mechanism allows for a time interval between the openings of the first and second electromechanical valves by a single mechanical operation of the user, without violating Halachic holy-day requirements.

1. A water dispenser having a week-day operation mode and a holy-day operation mode, the dispenser comprising:
a pressurized water feed line for receiving pressurized water from a pressurized water inlet;
a water treatment unit, in selective liquid communication with the pressurized water feed line through a first electromechanical valve fitted in the pressurized water feed line, the water treatment unit being configured to remove one or more contaminants from the water to obtain treated water;
a main water feed line, being in liquid communication with said water treatment unit to receive said treated water;
a cold water reservoir, configured to receive treated water from the main feed line through a first feed line, the cold water reservoir being in selective liquid communication with the first feed line through a second electromechanical valve fitted in the first feed line;
a cold water dispensing nozzle, in liquid communication with said cold water reservoir, configured for on-demand dispensing of cold water;
a hot water reservoir, configured to receive treated water from a second feed line, the second feed line being in selective liquid communication with the main feed line through a check-valve fitted between said main feed line and said second feed line and configured to permit passage of water from the main feed line to the hot water reservoir through the second feed line; and
a hot water dispensing nozzle, in liquid communication with said hot water reservoir, configured for on-demand dispensing of hot water via a third electromechanical valve;
during operation in week-days mode: (i) said first, second and third electromechanical valve being operated electrically on demand of cold or hot water, and (ii) the check valve permits passage of water from the main feed line to the hot water reservoir through the second feed line; and
during operation in holy-day mode: (i) said first, second and third electromechanical valves being operated mechanically, and (ii) the first and second electromechanical valves being mechanically coupled one to the other, such that mechanical opening the first electromechanical valve occurs at a delay from mechanical opening of the second electromechanical valve, the opening of the first electromagnetic valve at said delay from the second electromagnetic valve causes reduction in water pressure in the main feed line during dispensing of cold water from the cold water reservoir, thereby maintaining the water pressure in the main feed line below a pre-determined pressure threshold, such that the check valve is maintained closed to prevent water flow into the second feed line.

2. The water dispenser of claim 1, wherein the mechanical coupling between said first and second electromechanical valves provides a delay of at least 0.01 sec between mechanical opening of the second electromechanical valve and mechanical opening of the first electromechanical valve in the holy-day mode.

3. The water dispenser of claim 2, wherein said delay is between about 0.01 sec and about 0.5 sec.

4. The water dispenser of claim 1, wherein said cold water dispensing nozzle and said hot water dispensing nozzle are configured for (i) both electrical and mechanical dispensing operation in said week-day mode, and (ii) for mechanical dispensing operation only in said holy-day mode.

5. The water dispenser of claim 1, wherein the first electromechanical valve and the second electromechanical valve are coupled via a mechanical linking mechanism, the mechanical linking mechanism comprises:
a movement transitioning member that is mechanically linked to one or more cold-water dispensing mechanical operation actuators;
a first actuation element integral with said movement transitioning member, and configured for engaging with the first electromechanical valve; and
a second actuation element integral with the movement transitioning member, and configured for engaging with the second electromechanical valve;
the first and second actuation elements being configured to engage the second and first electromechanical valves, respectively, at a time difference of at least about 0.01 sec.

6. The water dispenser of claim 5, wherein:
the first electromechanical valve has a first plunger, configured to reciprocate along first stroke between a pressurized water flow-blocking position and a pressurized water flow-permitting position, the first actuation element being configured to displace the first plunger along said first stroke;
the second electromechanical valve has a second plunger, configured to reciprocate along a second stroke between a treated water flow-blocking position and a treated water flow-permitting position, the second actuation element being configured to displace the second plunger along said second stroke;
wherein, upon application of pressure on the one or more cold-water dispensing mechanical operation actuators, the movement transitioning member is configured to simultaneously displace the first and second actuation elements into simultaneous engagement with the respective first and second plungers,
and wherein the first stroke is larger than said second stroke, such that the first plunger reaches said treated water flow-permitting position at least about 0.01 sec after the second plunger reaches said pressurized water flow-permitting position.

7. The water dispenser of claim 1, wherein the check valve is configured to permit flow of water into the second feed line at a pre-determined pressure of at least about 0.2 bar.

8. The water dispenser of claim 1, comprising a cooling utility for cooling the cold water reservoir, wherein, when in holy-day mode, the cooling utility is configured to be operated intermittently in defined time intervals, irrespective of a measured water temperature in the cold water reservoir.

9. The water dispenser of claim 1, wherein the hot water reservoir comprises a first heating element, operating in low capacity to maintain a constant average temperature, and a second heating element operating intermittently at high capacity.

10. The water dispenser of claim 9, wherein the first and second heating elements are operated simultaneously both in week-day mode and holy-day mode.

11. The water dispenser of claim 1, wherein said water treatment unit comprises at least one filtering medium.

12. The water dispenser of claim 1, comprising a scale-removing cartridge, fitted in the second feed line, between the check valve and the hot water reservoir.

13. The water dispenser of claim 1, wherein said hot water dispensing nozzle comprises a hot water outlet tube, a nipple housing, and a hollow nipple accommodating in said nipple housing, the hollow nipple having a bottom opening that opens into the hot water outlet tube, the hollow nipple permitting suction of ambient air into the hot water outlet tube through said bottom opening to push residual water accumulating in the hot water dispensing tube towards a hot water outlet of the hot water dispensing nozzle.

14. The water dispenser of claim 1, comprising at least one ultraviolet (UV) radiation water treatment unit configured to treat the water by exposure to UV radiation.

15. The water dispenser of claim 14, wherein said UV radiation water treatment unit is positioned within the cold water reservoir.

16. The water dispenser of claim 1, comprising an ambient treated water dispensing nozzle, for selective dispensing of treated water at ambient temperature.

17. The water dispenser of claim 1, wherein said hot water dispensing nozzle and said cold water dispensing nozzle are vertically distanced one from the other along in a vertical direction extending normal to a base of the dispenser.

18. The water dispenser of claim 1, comprising at least one drip-tray positioned below said cold water and hot water dispensing nozzles.

19. The water dispenser of claim 18, wherein said at least one drip-tray comprises a first drip-tray is positioned below said cold water dispensing nozzle and a second drip-tray is positioned below said hot water dispensing nozzle.

20. The water dispenser of claim 18, wherein said at least one drip tray is foldable.

21. The water dispenser of claim 18, wherein said at least one drip tray is attachably detachable to the water dispenser.

22. The water dispenser of claim 1, comprising a control unit, configured to control operation of the dispenser for switching the dispenser between the week-day mode and the holy-day mode, and vice-versa.

23. The water dispenser of claim 22, wherein said control unit is configured to carry out said switch automatically.

24. The water dispenser of claim 22, wherein said control unit is configured to receive a command from a user to switch the dispenser between the week-day mode and the holy-day mode, and vice-versa.

25. The water dispenser of claim 1, wherein in holy-day mode dispensing of hot water from the hot water reservoir is gravitational.

26. The water dispenser of claim 1, further comprising a pressure regulator and/or a flow restrictor for regulating the pressure fed into the pressurized water feed line.
